(19) United States
(12) Patent Application Publication
(10) Pub. No.: US 2016/0240068 A1
(43) Pub. Date: Aug. 18, 2016

(54) OBJECT PROXIMITY ALARM SYSTEM

(71) Applicant: John R. Campas, SR., Wilkesberre, PA (US)

(72) Inventor: John R. Campas, SR., Wilkesberre, PA (US)

(21) Appl. No.: 15/041,278

(22) Filed: Feb. 11, 2016

Related U.S. Application Data
(63) Continuation-in-part of application No. 13/849,757, filed on Mar. 25, 2013, now abandoned.

(51) Int. Cl. G08B 21/24

(52) U.S. Cl. CPC G08B 21/24

(57) ABSTRACT

An object proximity alarm system comprising: a receiving bracelet, wherein said receiving bracelet includes a plurality of LED indicators; a plurality of transmitters, where each transmitter is associated with a LED indicator on the receiving bracelet and each transmitter transmit a signal to the receiving bracelet; a predetermined range associated with each signal transmitted; and an alarm on the receiving bracelet, where the alarm is triggered when on of the transmitter signal goes beyond the predetermined range associated with the transmitter. The alarm may include at least one of audio alarm, visual alarm associated with each LED indicator and a vibrating alarm. The transmitter may include a sticky surface or a hook and loop fastener for attachment onto an object.

### CROSS REFERENCE TO OTHER APPLICATIONS

This application is a continuation in part to U.S. patent application Ser. No. 13/849,757 filed on Mar. 25, 2013.

### BACKGROUND OF THE INVENTION

1. Field of Invention

The present invention is an object proximity alarm system that alerts a user of the proximity of an object.

2. Description of Related Art

Individuals must normally keep track of several personal items and devices especially in the digital age. Individuals often must remain aware of the location of several personal items such as glasses, cell phones, digital cameras, umbrellas, small tablet computers, laptops or other items. Further, individuals also must keep track of their children in a public place. Consequently due to the hectic schedules many individuals are engaged in many times personal items are lost or left behind unintendedly and therefore may be lost. Some items may be retained on an individual's person through the use of a clip or attachment belt while some items more than likely are simply misplaced and the individual simply loses track of it. Many times individuals may be distracted and allow an item to be left behind upon leaving a certain area. Consequently, it would be ideal to have a system engaged where an individual may receive an alarm if an object is misplaced prior to leaving a particular location or proximity to the personal item.

### SUMMARY OF THE INVENTION

The present invention relates to an object proximity alarm system comprising: a receiving bracelet, wherein said receiving bracelet includes a plurality of LED indicators; a plurality of transmitters, where each transmitter is associated with a LED indicator on the receiving bracelet and each transmitter transmit a signal to the receiving bracelet; a predetermined range associated with each signal transmitted; and an alarm on the receiving bracelet, where the alarm is triggered when on of the transmitter signal goes beyond the predetermined range associated with the transmitter. The alarm may include at least one of audio alarm, visual alarm associated with each LED indicator and a vibrating alarm. The transmitter may include a sticky surface or a hook and loop fastener for attachment onto an object.

### BRIEF DESCRIPTION OF DRAWINGS

FIG. 1 depicts a receiver bracelet used in conjunction with an object proximity alarm system according to the present invention.

FIG. 2 depicts a front view of a transmitter that is attached to an object in accordance with the present invention.

FIGS. 3A and 3B depict a back view of the transmitter used in accordance with the present invention.

### DETAILED DESCRIPTION

The present invention relates to an object proximity alarm system utilized to alert a user of the proximity of objects such as personal items or in certain instances children. The present proximity alarm system according to present invention utilizes a receiving bracelet which is worn by the user. This system further includes a transmitter which is attached to the object or personal item that is desired to be tracked through the proximity alarm system. The proximity alarm system according to present invention utilizes a small transmitter that is attached to the personal item which transmits a signal to the receiver bracelet which is worn by the user. The signal will be maintained as long as the item is within a predetermined range. Once the item is beyond a predetermined range the receiving bracelet alerts a visible alarm, an audible alarm and/or a vibrating alarm.

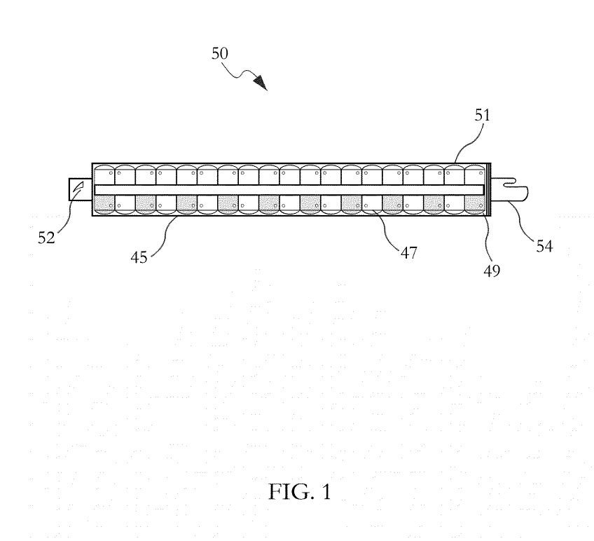

In reference to FIG. 1, a receiving bracelet 50 depicted in accordance with the present invention. The receiving bracelet 50 includes a main body 40 that has a series of LED indicators 47. The LED indicators 47 extend along the length of the main body 45. Each LED indicator 47 is associated with a particular transmitter that is attached to a personal item in order to track or maintain the location of the item. Further, the receiving bracelet 50 includes a clasp connector 54 and a clasp receiver 52 that allows an individual to attach the bracelet to their wrist. Once attached to the wrist, controls buttons 51 on one side of the main body 45 of the bracelet may be activated in order to receive in signals transmitted by a small transmitter that is attached to an object. The receiving bracelet 50 is therefore capable of connecting to a plurality of transmitters where a single LED indicator 47 is associated with a single transmitter of the plurality of transmitters.

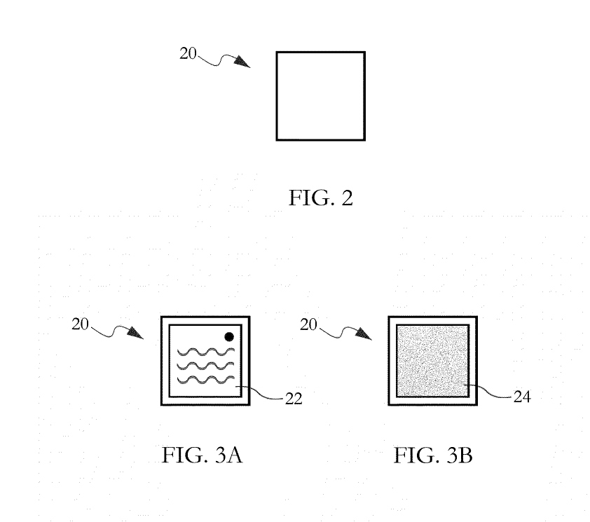

The bracelet 50 further includes audio speaker 49 not shown which emits an audible alarm to further alert a user of any item that is being left outside the proximity range set by the user. An exemplary transmitter 20 as depicted in FIG. 2 is placed upon an object item such as cell phone, a laptop or PDA or other personal items, which is tracked with the proximity system. This transmitter 20 may be attached through the use of a sticky surface 22 as depicted in FIG. 3A or through the use of a hook and loop fastener 24 as shown in FIG. 3B. The embodiments which depict the hook and loop fastener has a matching fastener attached to the personal item that is desired to be tracked to the proximity system.

During operation the proximity system according to the present invention utilizes an electronic signal, i.e., RS or blue tooth signal transmitted from the transmitter 20 to the bracelet 50. A predetermined range is set associated with the transmission signal. Once the bracelet 50 is outside of the range of the transmitter 20 an alarm is activated on the bracelet. As shown on the bracelet 50, the series of LED indicators 47 are shown along the main body 45. As a result a plurality of transmitters may be integrated into with the bracelet 50. Upon activation an indicator lights up and alerts a user of an item being left outside the range of the proximity system. Further an audible alarm may be emitted through the audio speaker 49 on the bracelet 50.

Although not specifically shown the bracelet may also include vibration technology as a third alarm option when used with the receiver bracelet 50. The receiving bracelet 50 therefore engages and alerts the user of any item that has a transmitter 20 attached to it. As stated, transmitter 20 may be attached to multiple personal item such as a cell phone on a computer, luggage bags, books, tablets or any items that an individual may carry and transport to various locations. Further the transmitter 20 may be also attached to a child in one specific embodiment where the proximity range may be increased and the signal sufficiently increased to alert a user of some ranges set by the user. The proximity alert system may therefore monitor the position of multiple transmitters and items. The proximity alert system therefore is very self-sufficient and perfect for alerting a user of mistakenly leaving items behind. The instant invention has been shown and described in what it considers to be the most practical and preferred embodiments. It is recognized, however, that departures may be made there from within the scope of the invention and that obvious modifications will occur to a person skilled in the art.

What is claimed is:

1. An object proximity alarm system comprising:
a. a receiving bracelet, wherein said receiving bracelet includes a plurality of individual LED indicators that extend along the length of the receiving bracelet;
b. a speaker on the receiving bracelet;
c. a plurality of transmitters, where each transmitter is associated with a LED indicator on the receiving bracelet and each transmitter transmit a signal to the receiving bracelet, where each transmitter attaches to an object via a sticky surface or a hook and loop fastener;
d. a predetermined range associated with each signal transmitted; and
e. an alarm on the receiving bracelet, where the alarm is triggered when on of the transmitter signal goes beyond the predetermined range associated with the transmitter.

2. The object proximity alarm system according to claim 1, where the alarm includes at least one of audio alarm, visual alarm associated with each LED indicator and a vibrating alarm.

3. The object proximity alarm system according to claim 1, where the signal transmitted from the transmitter is a blue tooth signal.

4. The object proximity alarm system according to claim 1, where the signal is an RF signal.

5. The object proximity alarm system according to claim 1, where the bracelet includes a clasp connector and a clasp receiver to enable attachment around a wrist.
